(19) United States
(12) Patent Application Publication
(10) Pub. No.: US 2009/0078511 A1
(43) Pub. Date: Mar. 26, 2009

(54) Brake Mechanism for a Caster Wheel on a Offset Rotary Mower

(75) Inventor: Stanley Joseph Boyko, Wakaw (CA)

Correspondence Address: Batoche Ag-Design, Box 1062, RR 1, Wakaw, SK, S0K 4P0, CA

(73) Assignee: BATOCHE AG-DESIGN, Wakaw (CA)

(21) Appl. No.: 11/941,028

(22) Filed: Nov. 15, 2007

(30) Foreign Application Priority Data
Sep. 21, 2007 (CA) 2598715

(51) Int. Cl. A01D 69/10

(52) U.S. Cl. 188/1.12

(57) ABSTRACT

A brake mechanism for a caster wheel(s) on an offset rotary mower apparatus wherein a hydraulic line or electric cable is connected at one end to the brake mechanism and at the other end to the tractor for remote control operation of the brake mechanism. The brake mechanism which is attached about the vertical caster axis of the caster wheel allows the caster wheel(s) to temporarily become a fixed wheel(s) when needed, assisting in reducing side draft load on the towing vehicle when the offset rotary mower apparatus is on steep slopes and enabling the offset rotary mower apparatus to be backed-up on the side slope of a ditch.

This invention is in the field of rotary mowers and in particular a brake mechanism for a caster wheel on an offset rotary mower. The brake mechanism allows the caster wheel to temporarily become a fixed wheel assisting in reducing side draft on the towing vehicle when the rotary mower is on a steep slope. The brake mechanism further assists by enabling the rotary mower to be backed-up on the side slope of the ditch.

### BACKGROUND OF THE INVENTION

Offset rotary mowers are used to maintain roadside ditches. Such offset apparatus' for ditch maintenance are disclosed in U.S. Pat. No. 6,854,250 to Boyko and U.S. Pat. No. 6,739,612 to Calistro. These offset rotary mowers require front wheels to support the front end of the mower when in the offset position. These wheels or wheel is usually a caster wheel to allow free movement of the mower from a tow behind position to an offset position in the ditch. When the mower is in the offset position from the tractor there is a side draft load on the tractor. This load varies directly with the grade of the slope, the steeper the slope the greater the side draft load. This side draft load can result in premature wear on the tractor tires as well as loss of steering control if the side draft load exceeds the weight of the tractor.

A second problem that occurs with the offset mower is its inability to be backed-up when on the side slope of the ditch. The caster wheels at the front results in the rotary mower always moving down the ditch slope when attempting to back-up. This inability to back-up can result in costly downtime when the mower inadvertently runs into an obstacle like a culvert and becomes hung up.

It would be desirable to have a mechanism that would allow the offset mower the ability to be backed-up when on the side slope of the ditch to increase the versatility of the apparatus and prevent costly downtime.

It would be desirable to have a mechanism that would reduce the side-draft load on the tractor when the mower is on a steep grade of the ditch increasing steering control and reducing tire wear.

It would be desirable if the mechanism were operative from the tractor seat for ease of operation.

### SUMMARY OF THE INVENTION

It is the first objective of the invention to provide a braking mechanism that when attached to the front caster wheel or wheels of an offset mower apparatus it would allow the front wheels of rotary mower apparatus to hold some of the draft load thereby reducing the side draft load on the towing vehicle.

It is a second objective of the present invention that the braking mechanism on the front caster wheel or wheels of the offset mower will allow the offset mower apparatus the ability to back-up when in the offset position on the side slope of the ditch.

It is a further object of the present invention that the braking mechanism on the front caster wheel or wheels of the offset mower apparatus be operative from the tractor seat allowing the operator ease of applying the brake mechanism as needed.

The present invention provides in one aspect a brake mechanism adapted for attachment to the front caster wheel on an offset mower apparatus. The brake mechanism is attached about the vertical caster axis of the front caster wheel to control caster at one end and attached at the tractor via hydraulic lines or electric cable running between, allowing the brake mechanism to be operative from the tractor seat.

When the offset mower apparatus is traveling on the side of a ditch and a steeper area approaches the brake mechanism can be applied through the hydraulic lines or electric cable. This causes the caster wheel(s) at the front to become a fixed wheel(s) allowing the draft load of the mower to shift from an exclusively side draft load on the tractor to a shared load on both tractor and the front wheel assembly of the mower apparatus; thereby reducing the side draft load on the tractor and improving steering control while decreasing rear tire wear on the tractor.

In a second aspect, the brake mechanism adapted for attachment to the front caster wheel(s) on an offset mower allows the offset rotary mower apparatus to be backed-up straight when on the side of the ditch. This brake mechanism when applied fixes the front caster wheel(s) so that the rotary mower apparatus moves in a straight line as it backs up rather then falling down the slope of the ditch.

### DESCRIPTION OF THE DRAWINGS

While the invention is claimed in the concluding portions hereof, preferred embodiments are provided in the accompany detailed description which may be understood in conjunction with the accompanying diagrams where like parts in each of the several diagrams are labeled with like numbers, and where:

FIG. 1 is the front isometric view of an offset rotary mower apparatus with the brake mechanism of the embodiment of the invention on the front caster wheels. Detail of the brake mechanism is shown.

FIG. 2 is the rear isometric view of the brake mechanism of the embodiment of the invention on the front caster wheel assembly of an offset rotary mower apparatus.

### DETAILED DESCRIPTION OF THE INVENTION

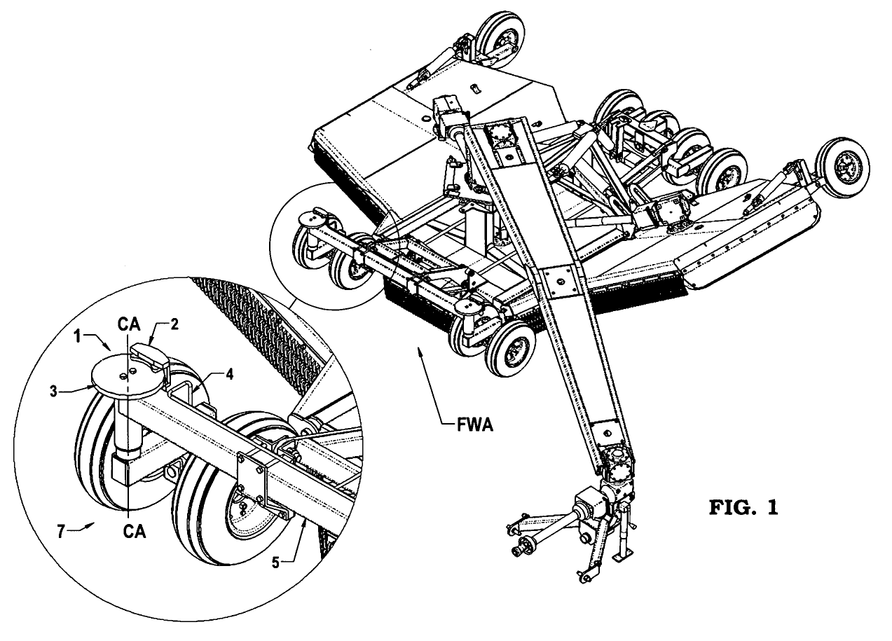

FIG. 1 illustrates the brake mechanism of the invention for attachment to a caster wheel of an offset rotary mower apparatus to enable a back-up maneuver on a side slope of a ditch and to assist the tractor on steep slopes. This is done by remotely applying the brake mechanism 1. This results in the front caster wheels 7 temporarily becoming a fixed wheel system enabling the offset rotary mower apparatus to be backed-up on the slope of the ditch, because the wheels will follow straight instead of falling down the slope and jack knifing. When the brake mechanism 1 is applied on steep slopes as needed, the fixed wheels will allow the front wheel assembly FWA to take on some of the draft load of the mower. Thus improving steering control on the tractor and reducing rear tire wear. The brake mechanism 1 comprises a brake caliper 2, a brake rotor 3 and hydraulic lines 4 or an electric cable for actuating the brake caliper 2 remotely from the tractor.

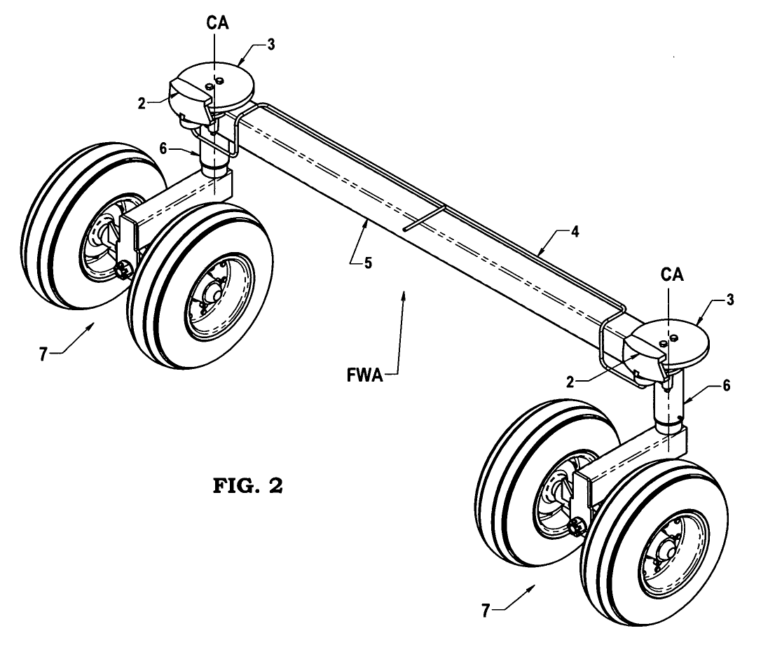

FIG. 2 illustrates the brake mechanism of the invention as it is attached to the front caster wheel(s) 7 of an offset mower apparatus. The brake caliper 2 is fixedly attached to the front cross member 5 of the front wheel assembly FWA. The brake rotor 3 is mounted to the vertical shaft 6. The vertical shaft 6 is for caster about the caster axis CA. The hydraulic lines 4 are connected to the caliper 2 at one end and to the tractor at the other end, by a separate circuit (or can be tapped into an existing hydraulic circuit) for remote control of the hydraulics to the caliper 2. When the caliper 2 is activated by the hydraulics 4 or an electric cable the brake caliper 2 applies pressure to the brake rotor 3 preventing the shaft 6 from castering about its CA thereby making the caster wheel(s) 7 a fixed wheel(s).

The foregoing is considered as illustrative only of the principals of the invention. Further, since numerous changes and modifications will occur to those skilled in the art, it is not desired to limit the invention to the exact construction and operation shown and described, and accordingly, all such suitable changes or modifications in structure or operation which may be resorted to fall within scope of the claimed invention.

I claim:

1. A brake mechanism adapted for attachment to a caster wheel of an offset rotary mower apparatus wherein the brake mechanism is attached about the caster axis of the caster wheel to control caster.

2. A brake mechanism adapted for attachment to a caster wheel of an offset rotary mower apparatus wherein the brake mechanism is attached about the caster axis of the caster wheel to control caster and wherein hydraulic lines or electric cable are connected to the brake mechanism at one end and at the other end to the tractor to allow remote control operation of the brake mechanism from the tractor seat.

3. A brake mechanism adapted for attachment to a front caster wheel of an offset rotary mower apparatus; the brake mechanism comprises;
a brake caliper
a brake rotor
and hydraulic lines or an electric cable;
wherein the brake caliper is fixedly attached to the front cross member of the front caster wheel of an offset rotary mower apparatus and the brake rotor is fixedly attached to the vertical shaft that casters on the caster axis on the front caster wheel.

4. The brake mechanism of claim 3 wherein the hydraulic lines or electric cable are connected to the brake caliper at one end and to the controls within the tractor at the other end to allow remote control operation of the brake mechanism from the tractor seat.
